(19) United States
(12) Patent Application Publication
(10) Pub. No.: US 2024/0155602 A1
(43) Pub. Date: May 9, 2024

(54) INDICATION OF UPLINK TRANSMISSION PRECODING PARAMETER CHANGE

(71) Applicant: QUALCOMM Incorporated, San Diego, CA (US)

(72) Inventors: Diana MAAMARI, San Diego, CA (US); Ahmed ELSHAFIE, San Diego, CA (US); Wei YANG, San Diego, CA (US); Huilin XU, Temecula, CA (US)

(21) Appl. No.: 18/052,451

(22) Filed: Nov. 3, 2022

(51) Int. Cl. H04W 72/12; H04B 7/0456; H04W 72/04; H04W 72/14

(52) U.S. Cl. CPC H04W 72/1268; H04B 7/0456; H04W 72/0413; H04W 72/1289; H04W 72/14

(57) ABSTRACT

Various aspects of the present disclosure generally relate to wireless communication. In some aspects, a user equipment (UE) may receive, from a network node, configuration information for a configured grant, the configuration information indicating one or more uplink transmission precoding parameters for the configured grant. The UE may transmit, to the network node, an indication of a change to at least one uplink transmission precoding parameter of the one or more uplink transmission precoding parameters for the configured grant. The UE may transmit, to the network node, an uplink transmission in a configured grant occasion associated with the configured grant with the at least one uplink transmission precoding parameter based at least in part on the indication of the change to the at least one uplink transmission precoding parameter. Numerous other aspects are described.

### FIELD OF THE DISCLOSURE

Aspects of the present disclosure generally relate to wireless communication and to techniques and apparatuses for indication of an uplink transmission precoding parameter change.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network node, configuration information for a configured grant, the configuration information indicating one or more uplink transmission precoding parameters for the configured grant. The one or more processors may be configured to transmit, to the network node, an indication of a change to at least one uplink transmission precoding parameter of the one or more uplink transmission precoding parameters for the configured grant. The one or more processors may be configured to transmit, to the network node, an uplink transmission in a configured grant occasion associated with the configured grant with the at least one uplink transmission precoding parameter based at least in part on the indication of the change to the at least one uplink transmission precoding parameter.

Some aspects described herein relate to a network node for wireless communication. The network node may include a memory and one or more processors coupled to the memory. The one or more processors may be configured to transmit, to a UE, configuration information for a configured grant, the configuration information indicating one or more uplink transmission precoding parameters for the configured grant. The one or more processors may be configured to receive, from the UE, an indication of a change to at least one uplink transmission precoding parameter of the one or more uplink transmission precoding parameters for the configured grant. The one or more processors may be configured to receive, from the UE, an uplink transmission in a configured grant occasion associated with the configured grant with the at least one uplink transmission precoding parameter based at least in part on the indication of the change to the at least one uplink transmission precoding parameter.

Some aspects described herein relate to a method of wireless communication performed by a UE. The method may include receiving, from a network node, configuration information for a configured grant, the configuration information indicating one or more uplink transmission precoding parameters for the configured grant. The method may include transmitting, to the network node, an indication of a change to at least one uplink transmission precoding parameter of the one or more uplink transmission precoding parameters for the configured grant. The method may include transmitting, to the network node, an uplink transmission in a configured grant occasion associated with the configured grant with the at least one uplink transmission precoding parameter based at least in part on the indication of the change to the at least one uplink transmission precoding parameter.

Some aspects described herein relate to a method of wireless communication performed by a network node. The method may include transmitting, to a UE, configuration information for a configured grant, the configuration information indicating one or more uplink transmission precoding parameters for the configured grant. The method may include receiving, from the UE, an indication of a change to at least one uplink transmission precoding parameter of the one or more uplink transmission precoding parameters for the configured grant. The method may include receiving, from the UE, an uplink transmission in a configured grant occasion associated with the configured grant with the at least one uplink transmission precoding parameter based at least in part on the indication of the change to the at least one uplink transmission precoding parameter.

Some aspects described herein relate to a non-transitory computer-readable medium that stores a set of instructions for wireless communication by a UE. The set of instructions, when executed by one or more processors of the UE, may cause the UE to receive, from a network node, configuration information for a configured grant, the configuration information indicating one or more uplink transmission precoding parameters for the configured grant. The set of instructions, when executed by one or more processors of the UE, may cause the UE to transmit, to the network node, an indication of a change to at least one uplink transmission precoding parameter of the one or more uplink transmission precoding parameters for the configured grant. The set of instructions, when executed by one or more processors of the UE, may cause the UE to transmit, to the network node, an uplink transmission in a configured grant occasion associated with the configured grant with the at least one uplink transmission precoding parameter based at least in part on the indication of the change to the at least one uplink transmission precoding parameter.

Some aspects described herein relate to a non-transitory computer-readable medium that stores a set of instructions for wireless communication by a network node. The set of instructions, when executed by one or more processors of the network node, may cause the network node to transmit, to a UE, configuration information for a configured grant, the configuration information indicating one or more uplink transmission precoding parameters for the configured grant. The set of instructions, when executed by one or more processors of the network node, may cause the network node to receive, from the UE, an indication of a change to at least one uplink transmission precoding parameter of the one or more uplink transmission precoding parameters for the configured grant. The set of instructions, when executed by one or more processors of the network node, may cause the network node to receive, from the UE, an uplink transmission in a configured grant occasion associated with the configured grant with the at least one uplink transmission precoding parameter based at least in part on the indication of the change to the at least one uplink transmission precoding parameter.

Some aspects described herein relate to an apparatus for wireless communication. The apparatus may include means for receiving, from a network node, configuration information for a configured grant, the configuration information indicating one or more uplink transmission precoding parameters for the configured grant. The apparatus may include means for transmitting, to the network node, an indication of a change to at least one uplink transmission precoding parameter of the one or more uplink transmission precoding parameters for the configured grant. The apparatus may include means for transmitting, to the network node, an uplink transmission in a configured grant occasion associated with the configured grant with the at least one uplink transmission precoding parameter based at least in part on the indication of the change to the at least one uplink transmission precoding parameter.

Some aspects described herein relate to an apparatus for wireless communication. The apparatus may include means for transmitting, to a UE, configuration information for a configured grant, the configuration information indicating one or more uplink transmission precoding parameters for the configured grant. The apparatus may include means for receiving, from the UE, an indication of a change to at least one uplink transmission precoding parameter of the one or more uplink transmission precoding parameters for the configured grant. The apparatus may include means for receiving, from the UE, an uplink transmission in a configured grant occasion associated with the configured grant with the at least one uplink transmission precoding parameter based at least in part on the indication of the change to the at least one uplink transmission precoding parameter.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of uplink configured grant communication, in accordance with the present disclosure.

FIGS. 5-6 are diagrams illustrating examples associated with indication of an uplink transmission precoding parameter change, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

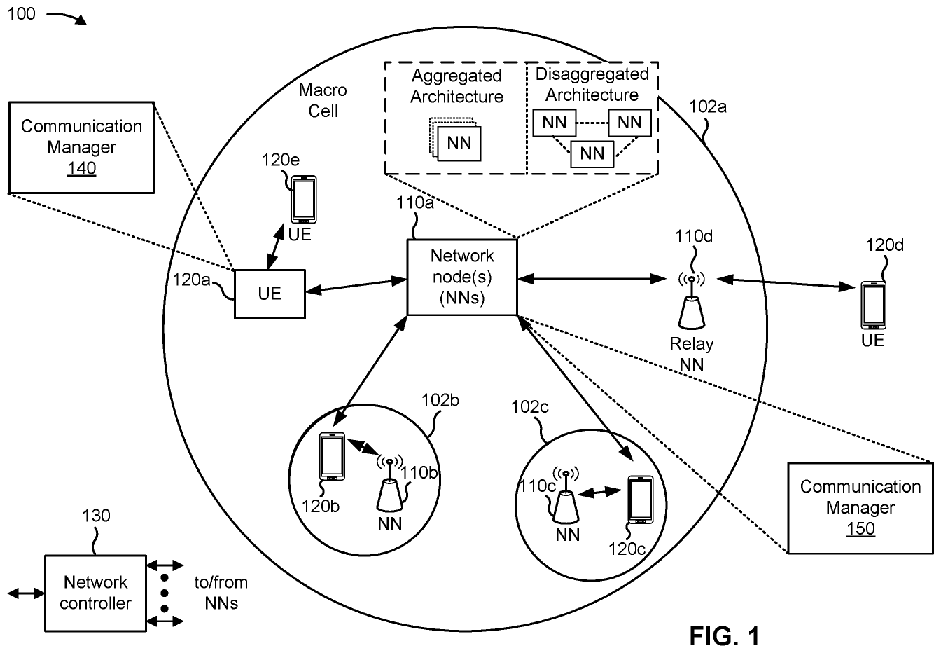

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, configuration information for a configured grant, the configuration information indicating one or more uplink transmission precoding parameters for the configured grant; transmit, to the network node, an indication of a change to at least one uplink transmission precoding parameter of the one or more uplink transmission precoding parameters for the configured grant; and transmit, to the network node, an uplink transmission in a configured grant occasion associated with the configured grant with the at least one uplink transmission precoding parameter based at least in part on the indication of the change to the at least one uplink transmission precoding parameter. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information for a configured grant, the configuration information indicating one or more uplink transmission precoding parameters for the configured grant; receive, from the UE, an indication of a change to at least one uplink transmission precoding parameter of the one or more uplink transmission precoding parameters for the configured grant; and receive, from the UE, an uplink transmission in a configured grant occasion associated with the configured grant with the at least one uplink transmission precoding parameter based at least in part on the indication of the change to the at least one uplink transmission precoding parameter. Additionally, or alternatively, the communication manager 150 may perform one or more other operations described herein.

As indicated above, FIG. 1 is provided as an example. Other examples may differ from what is described with regard to FIG. 1.

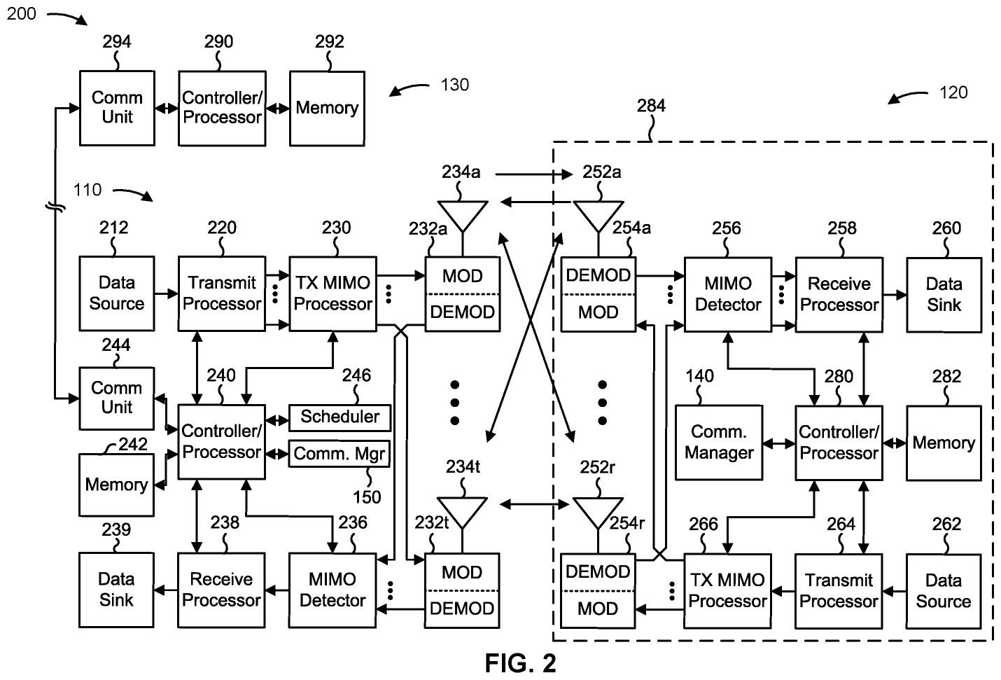

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MC S(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

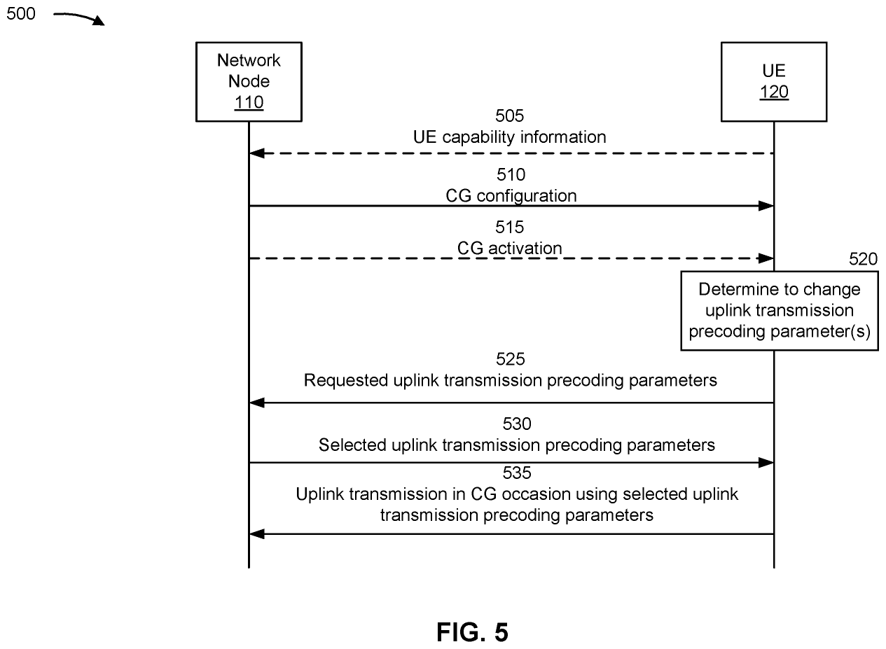

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

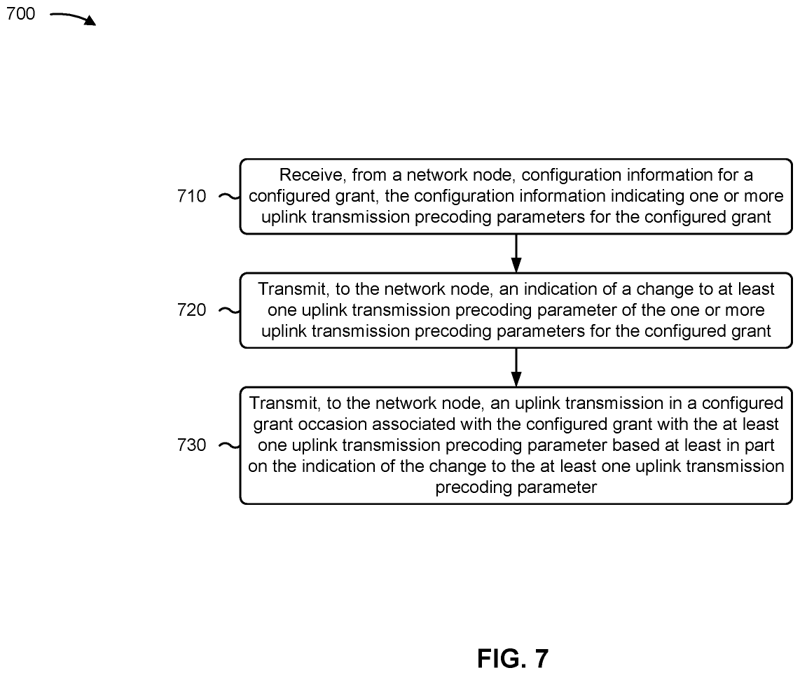

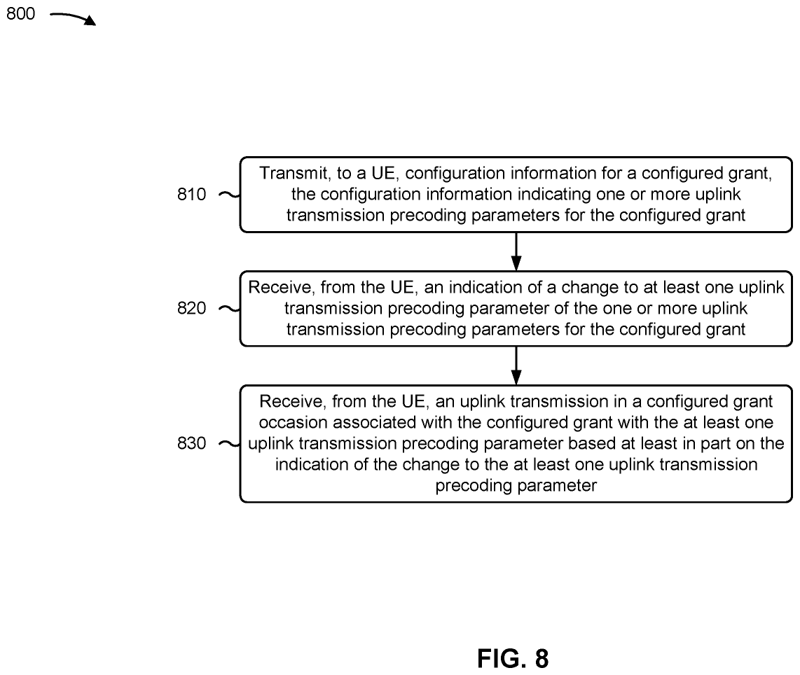

The controller/processor 240 of the network node 110, the controller/processor 280 of the UE 120, and/or any other component(s) of FIG. 2 may perform one or more techniques associated with indication of an uplink transmission precoding parameter change, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, configuration information for a configured grant, the configuration information indicating one or more uplink transmission precoding parameters for the configured grant; means for transmitting, to the network node, an indication of a change to at least one uplink transmission precoding parameter of the one or more uplink transmission precoding parameters for the configured grant; and/or means for transmitting, to the network node, an uplink transmission in a configured grant occasion associated with the configured grant with the at least one uplink transmission precoding parameter based at least in part on the indication of the change to the at least one uplink transmission precoding parameter. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, configuration information for a configured grant, the configuration information indicating one or more uplink transmission precoding parameters for the configured grant; means for receiving, from the UE, an indication of a change to at least one uplink transmission precoding parameter of the one or more uplink transmission precoding parameters for the configured grant; and/or means for receiving, from the UE, an uplink transmission in a configured grant occasion associated with the configured grant with the at least one uplink transmission precoding parameter based at least in part on the indication of the change to the at least one uplink transmission precoding parameter. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

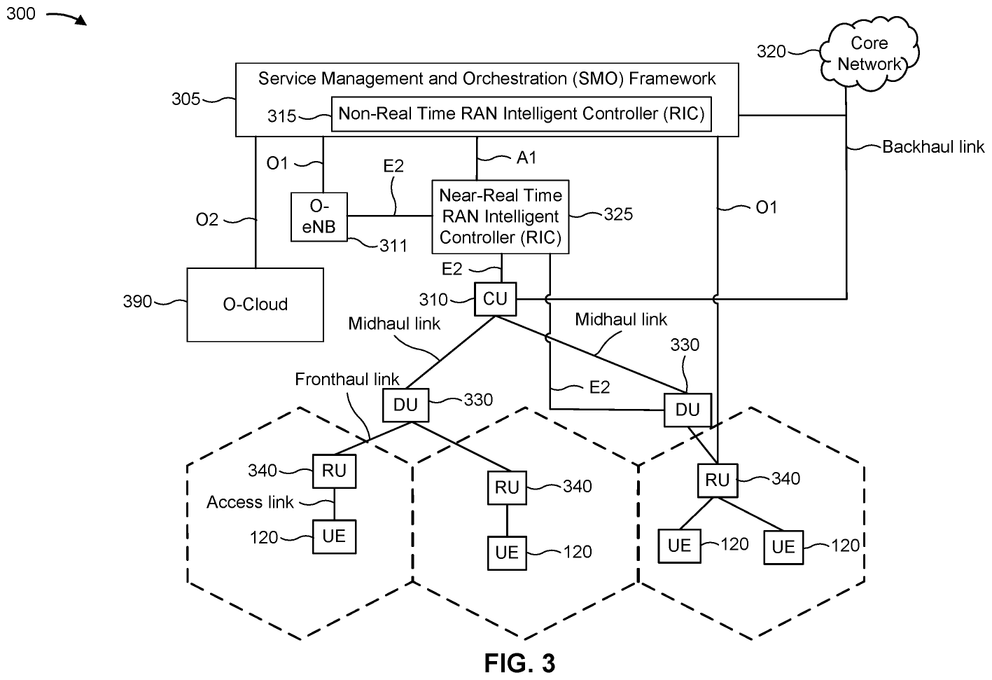

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT MC 325 via an E2 link, or a Non-RT MC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

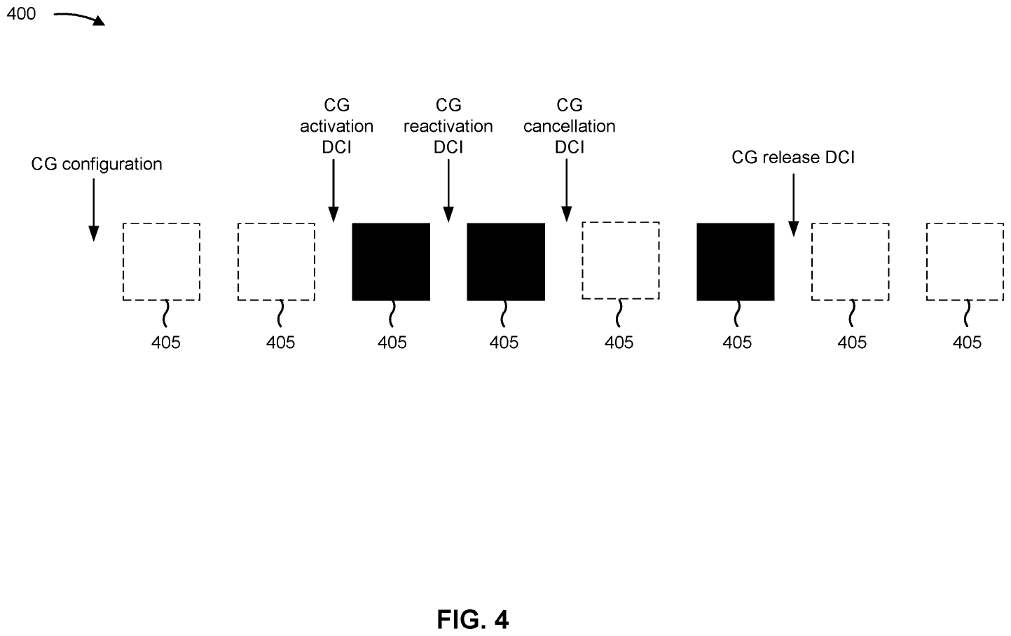

FIG. 4 is a diagram illustrating an example 400 of uplink configured grant (CG) communication, in accordance with the present disclosure. CG communications may include periodic uplink communications that are configured for a UE, such that the network node does not need to transmit (e.g., directly or via one or more network nodes) separate downlink control information (DCI) to schedule each uplink communication, thereby conserving signaling overhead.

As shown in example 400, a UE may be configured with a CG configuration for CG communications. For example, the UE may receive the CG configuration via an RRC message transmitted by a network node (e.g., directly to the UE or via one or more network nodes). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 405 for the UE. In some examples, the CG configuration may identify a resource pool or multiple resource pools that are available to the UE for an uplink transmission. In some examples, an RRC CG configuration (e.g., ConfiguredGrantConfig) may indicate uplink transmission precoding parameters, such as a transmit precoding matrix indicator (TPMI), a rank indicator (RI), and a sounding reference signal (SRS) resource indicator (SRI). For example, the RRC CG configuration (e.g., ConfiguredGrantConfig) may include a precodingAndNumberofLayers information element that indicates the TPMI and the RI, and the RRC CG configuration (e.g., ConfiguredGrantConfig) may include an srs-ResourceIndicator information element that indicates the SRI. The UE may determine precoder information (e.g., a precoder matrix) for the CG uplink communications based on the TPMI, RI, and SRI indicated in the CG configuration. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The UE may be configured with a type of uplink CG (e.g., CG Type 1) that does not require DCI activation, or a type of uplink CG (e.g., CG Type 2) that requires DCI activation. As shown in FIG. 4, in a case in which the UE is configured with the type of uplink CG (e.g., CG Type 2) that requires DCI activation, the network node may transmit CG activation DCI to the UE (e.g., directly or via one or more network nodes) to activate the CG configuration for the UE. The network node may indicate, in the CG activation DCI, communication parameters, such as an MCS, an RB allocation, and/or antenna ports, for the CG physical uplink shared channel (PUSCH) communications to be transmitted in the scheduled CG occasions 405. The UE may begin transmitting in the CG occasions 405 based at least in part on receiving the CG activation DCI. For example, beginning with a next scheduled CG occasion 405 subsequent to receiving the CG activation DCI, the UE may transmit PUSCH communications in the scheduled CG occasions 405 using the communication parameters indicated in the CG activation DCI. In the case in which the UE is configured with CG Type 2, the UE may refrain from transmitting in configured CG occasions 405 prior to receiving the CG activation DCI. In other examples, in a case in which the UE is configured with the type of uplink CG (e.g., CG Type 1) that does not require DCI activation, the CG may be activated in connection with the UE receiving the CG configuration. In this case, the UE may begin transmitting in the CG occasions 405 beginning with a first scheduled CG occasion 405 subsequent to receiving the CG configuration.

In some cases in which a UE is configured with CG Type 2, the network node may transmit CG reactivation DCI to the UE (e.g., directly or via one or more network nodes) to change the communication parameters for the CG PUSCH communications. Based at least in part on receiving the CG reactivation DCI, the UE may begin transmitting in the scheduled CG occasions 405 using the communication parameters indicated in the CG reactivation DCI. For example, beginning with a next scheduled CG occasion 405 subsequent to receiving the CG reactivation DCI, the UE may transmit PUSCH communications in the scheduled CG occasions 405 based at least in part on the communication parameters indicated in the CG reactivation DCI.

In some cases, such as when the network node needs to override a scheduled CG communication for a higher priority communication, the network node may transmit CG cancellation DCI to the UE (e.g., directly or via one or more network nodes) to temporarily cancel or deactivate one or more subsequent CG occasions 405 for the UE. The CG cancellation DCI may deactivate only a subsequent single CG occasion 405 or a subsequent N CG occasions 405 (where N is an integer). CG occasions 405 after the one or more (e.g., N) CG occasions 405 subsequent to the CG cancellation DCI may remain activated. Based at least in part on receiving the CG cancellation DCI, the UE may refrain from transmitting in the one or more (e.g., N) CG occasions 405 subsequent to receiving the CG cancellation DCI. As shown in example 400, the CG cancellation DCI cancels one subsequent CG occasion 405 for the UE. After the CG occasion 405 (or N CG occasions) subsequent to receiving the CG cancellation DCI, the UE may automatically resume transmission in the scheduled CG occasions 405.

In some cases in which the UE is configured with CG Type 2, the network node may transmit CG release DCI to the UE (e.g., directly or via one or more network nodes) to deactivate the CG configuration for the UE. The UE may stop transmitting in the scheduled CG occasions 405 based at least in part on receiving the CG release DCI. For example, the UE may refrain from transmitting in any scheduled CG occasions 405 until another CG activation DCI is received by the UE. Whereas the CG cancellation DCI may deactivate only a subsequent one CG occasion 405 or a subsequent N CG occasions 405, the CG release DCI deactivates all subsequent CG occasions 405 for a given CG configuration for the UE until the given CG configuration is activated again by a new CG activation DCI.

As indicated above, FIG. 4 is provided as an example. Other examples may differ from what is described with respect to FIG. 4.

In some examples, NR PUSCH communications for a UE may be scheduled by dynamic uplink grant (e.g., DG-PUSCH) transmitted to the UE from a network node via DCI. In other examples, PUSCH communications for a UE may be transmitted via a CG (e.g., CG-PUSCH) configured for the UE without the UE receiving a dynamic uplink grant. For example, the CG configured for a UE may be CG Type 1 or CG Type 2, as described above in connection with FIG. 4. In the case of DG-PUSCH, transmission precoding parameters, such as TPMI, RI, and SRI, for the PUSCH transmission may be indicated in the DCI that schedules the PUSCH transmission (e.g., the dynamic uplink grant DCI). For example, the network node may determine an uplink beam, as well as a precoder and rank for the uplink beam, based at least in part on uplink SRS channel estimation and codebook subset restriction, and the network node may indicate the uplink beam (e.g., SRI), the precoder (e.g., TPMI), and the rank (e.g., RI) in the DCI that schedules an uplink transmission (e.g., a PUSCH transmission).

In the case of CG uplink transmissions, the transmission precoding parameters may be configured via an RRC configuration. For example, TPMI, RI, and SRI are RRC configured for CG Type 1, and changes to the CG configuration are indicated via RRC signaling. In the event of a blockage or mobility of the UE, the network node may indicate changes to the CG Type 1 transmission precoding parameters (e.g., TPMI, RI, and SRI) via RRC signaling. However, RRC signaling is slow as compared to a dynamic indication (e.g., via DCI), and CG Type 1 may not dynamically adapt to channel variations. Thus, changes to the CG transmission precoding parameters indicated via RRC signaling may cause a higher block error rate (BLER) and packer error rate (PER), resulting in decreased reliability and increased latency for CG uplink transmissions, as compared to dynamically switching transmission precoding parameters. Although CG Type 2 allows for dynamic indication of the transmission precoding parameters using the activation DCI (and/or reactivation DCI), the transmission precoding parameters that can be indicated in the activation DCI (and/or reactivation DCI) are limited to transmission precoding parameters selected from those configured in the CG configuration. Accordingly, the network node may not be able to dynamically select transmission precoding parameters that are most appropriate for the current channel conditions (e.g., in the event of a blockage or UE mobility), which may result in decreased reliability and increased latency for CG uplink transmissions. Furthermore, changing the transmission precoding parameters once the CG has been activated utilizes additional DCI (e.g., reactivation) transmissions, which reduces UE power saving associated with CG uplink transmissions.

Some techniques and apparatuses described herein enable a UE to receive, from a network node, configuration information for a CG. The configuration information may indicate one or more uplink transmission precoding parameters for the CG. The UE may transmit, to the network node, an indication of a change to at least one uplink transmission precoding parameter for the configured grant. The UE may transmit, to the network node, an uplink transmission in a configured grant occasion with the at least one uplink transmission precoding parameter based at least in part on the indication of the change to the at least one uplink transmission precoding parameter. As a result, the UE may initiate a dynamic change to at least one transmission precoding parameter for a CG uplink transmission, for example, in the event of a blockage, UE mobility, and/or other changes in channel conditions. Such a dynamic change to a transmission precoding parameter may increase reliability and reduce latency of CG uplink communications, as compared to changing the transmission precoding parameter via RRC signaling. Furthermore, the dynamic change in the transmission precoding parameter may not be limited to a selection from transmission precoding parameters configured in the CG configuration. Accordingly, the UE may dynamically change the transmission precoding parameter to a transmission precoding parameter that is most appropriate for the current channel conditions, which may result in increased reliability and decreased latency for CG uplink transmissions, as compared to activation/reactivation DCI indicating a selection from configured values for the transmission precoding parameter in the case of CG Type 2. In some aspects, the UE may dynamically change at least one transmission precoding parameter for a CG without receiving additional signaling from the network node, which may reduce power consumption at the UE as compared with receiving activation/reactivation DCI that indicates a change to the at least one transmission parameter in the case of CG Type 2.

FIG. 5 is a diagram illustrating an example 500 associated with indication of an uplink transmission precoding parameter change, in accordance with the present disclosure. As shown in FIG. 5, example 500 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 5, and by reference number 505, the UE 120 may transmit, and the network node 110 may receive, UE capability information. In some aspects, the UE capability information may indicate a capability of the UE 120 to determine an analog or digital uplink beam. For example, the UE capability information may indicate a capability of the UE 120 to determine a capability of the UE 120 to determine an analog or digital uplink beam over time and/or a capability of the UE 120 to determine an updated uplink beam when beam blocking occurs without channel state information (CSI) reference signal (CSI-RS) reception. In some aspects, the transmission, by the UE 120, of an indication of a change to at least one uplink transmission precoding parameter, described elsewhere herein, may be based at least in part on the UE capability indicated in the UE capability information. For example, in some aspects, the transmission, by the UE 120, of requested uplink transmission precoding parameters, described below in connection with reference number 525, may be based at least in part on the UE capability indicated in the UE capability information.

As further shown in FIG. 5, and by reference number 510, the network node 110 may transmit, to the UE 120, a CG configuration. The UE 120 may receive the CG configuration transmitted by the network node 110. In some aspects, the network node 110 may transmit, and the UE 120 may receive, configuration information that indicates the CG configuration. For example, the configuration information may indicate a configuration for a CG for the UE 120. In some aspects, the configuration information that indicates the CG configuration may be transmitted to the UE 120 in an RRC message. The CG configuration may configure a CG with periodically recurring uplink resources for CG uplink transmissions. For example, the CG configuration may indicate a resource allocation for transmitting CG uplink transmissions (e.g., in a time domain, frequency domain, spatial domain, and/or code domain) and a periodicity at which the resource allocation is repeated, resulting in periodically reoccurring scheduled CG occasions for the UE 120.

The CG configuration may indicate uplink transmission precoding parameters for the CG uplink transmissions, such as an SRI, a TPMI, and an RI. For example, the CG configuration (e.g., ConfiguredGrantConfig) may include a precodingAndNumberofLayers information element that indicates the TPMI and the RI, and the CG configuration (e.g., ConfiguredGrantConfig) may include an srs-ResourceIndicator information element that indicates the SRI. The CG configured by the CG configuration may be a CG Type 1 (e.g., that does not require activation) or a CG Type 2 (e.g., that is activated via DCI activation). In a case in which the CG is a CG Type 1, the CG configuration may indicate a set of uplink transmission precoding parameters (e.g., SRI, TPMI, and RI) to be used by the UE 120 for the CG uplink transmissions in the CG occasions. In a case in which the CG is a CG Type 2, the CG configuration may indicate multiple sets of uplink transmission precoding parameters (e.g., SRI, TPMI, and RI), and the activation DCI that activates the CG configuration may indicate a set of uplink transmission precoding parameters (e.g., SRI, TPMI, and RI), among the multiple sets of uplink transmission precoding parameters indicated in the CG configuration, to be used by the UE 120 for the CG uplink transmissions in the CG occasions.

As further shown in FIG. 5, and by reference number 515, in some aspects, the network node 110 may transmit, and the UE 120 may receive, a CG activation indication that indicates activation of the CG configured for the UE 120. For example, the network node 110 may transmit, and the UE 120 may receive, CG activation DCI that indicates activation of the CG configured for the UE 120. In some aspects, the network node 110 may transmit the CG activation DCI to the UE 120 to activate the CG configured for the UE 120 in a case in which the CG is a CG Type 2. In this case, the periodic CG occasions for the CG may be activated for the UE 120 based at least in part on the UE 120 receiving the CG activation DCI. In some aspects, the CG activation DCI may indicate a set of uplink transmission precoding parameters (e.g., SRI, TPMI, and RI), among multiple sets of uplink transmission precoding parameters indicated in the CG configuration, to be used by the UE 120 for the CG uplink transmissions in the periodic CG occasions activated by the CG activation DCI.

In some aspects, in a case in which the CG configured for the UE 120 is a CG Type 1, the CG may not require DCI activation. In this case, the network node 110 may not transmit the CG activation indication (e.g., the CG activation DCI) to the UE 120, and the periodic CG occasions for the CG may be activated for the UE 120 based at least in part on the UE 120 receiving the CG configuration, without receiving the CG activation DCI.

Once the CG is activated, the UE 120 may transmit uplink transmissions in the periodic CG occasions associated with the CG. The UE 120 may transmit uplink transmissions in one or more CG occasions associated with the CG using the configured uplink transmission precoding parameters (e.g., SRI, TPMI, and RI) indicated in the CG configuration (e.g., for CG Type 1) and/or the CG activation DCI (e.g., for CG Type 2). For example, the UE 120 may determine an uplink beam (e.g., a precoder matrix) for the uplink transmissions in the CG occasions based at least in part on the configured values of SRI, TPMI, and RI.

As further shown in FIG. 5, and by reference number 520, the UE 120 may determine to change at least one uplink transmission precoding parameter for the CG. For example, the UE 120 may determine to change at least one of the SRI, the TPMI, or the RI for the CG. In some aspects, the UE 120 may determine to change one or more of the uplink transmission precoding parameters for the CG based at least in part on detecting or determining that a beam blockage has occurred. In some aspects, the UE 120 may determine to change one or more of the uplink transmission precoding parameters for the CG based at least in part on detecting or determining a mobility event associated with the UE 120.

In some aspects, the UE 120 may determine to change or more of the uplink transmission precoding parameters for the CG based at least in part on a determination, by the UE 120, of a better uplink beam than a current uplink beam associated with the current uplink transmission precoding parameters. For example, a better uplink beam may be a beam that results in an increase by more than a threshold amount in power (e.g., RSRP) and/or quality (e.g., RSRQ) measurements (e.g., measured or predicted), as compared with the current uplink beam. In some aspects, the UE 120 may receive, from the network node 110, multiple downlink transmissions including CSI-RSs for the purpose of uplink TPMI determination. For example, the CSI-RSs may include periodic CSI-RS transmissions. The UE 120 may perform measurements (e.g., RSRP and/or RSRQ measurements) on the downlink transmissions (e.g., the CSI-RSs), and the UE 120 may determine an uplink TPMI based at least in part on the measurements. In this case, the UE 120 may determine a better TPMI (e.g., a TPMI value that results in a better uplink beam than the current uplink beam) that is different from the current TPMI value (e.g., the configured TPMI value) for the CG based at least in part on one or more measurements (e.g., RSRP and/or RSRQ measurements) performed on one or more downlink transmissions (e.g., one or more CSI-RSs) received by the UE 120.

In some aspects, the UE 120 may determine/predict a better TPMI that is different/distinct from the current TPMI (e.g., the configured TPMI) for the CG without receiving and/or measuring CSI-RSs based at least in part on a machine learning (ML) model and a set of training data. For example, the UE 120 may include (e.g., be configured with) the ML model, and the ML model may be trained using the set of training data. The UE 120 may use the ML model to predict a TPMI based at least in part on a history of data reception and/or CSI-RS reception for the UE 120.

As further shown in FIG. 5, and by reference number 525, the UE 120 may transmit, and the network node 110 may receive, an indication of the one or more requested uplink transmission precoding parameters. In some aspects, the UE 120 may transmit, and the network node 110 may receive, an indication of a set of requested values for at least one uplink transmission precoding parameter. For example, the UE 120 may transmit the indication of the set of requested values for the at least one uplink transmission precoding parameter based at least in part on the determination to change the at least one transmission precoding parameter. In this case, the indication of the set of requested values for the at least one uplink transmission precoding parameter may provide, to the network node 110, an indication of a change (e.g., a requested change initiated by the UE 120) to the at least one uplink transmission precoding parameter. In some aspects, the UE 120 may transmit the indication of the set of requested values for the at least one uplink transmission precoding parameter to the network node 110 in an uplink CSI report. For example, the uplink CSI report may be carried on a physical uplink control channel (PUCCH) or a PUSCH (e.g., on reserved resource blocks (RBs) of the PUSCH for multiplexing CSI).

In some aspects, the indication of the set of requested values for the at least one uplink transmission precoding parameter may indicate K requested values for the at least one uplink transmission precoding parameter. For example, the at least one uplink transmission precoding parameter may include at least one of the SRI, the TPMI, or the RI. That is, the K requested values for the at least one uplink transmission precoding parameter may include K requested values for each of the SRI, the TPMI, and/or the RI. In some aspects, the indication of the set of requested values (e.g., included in the uplink CSI report) may indicate K (SRI, TPMI, RI) parameter sets (e.g., K (SRI, TPMI, RI) tuples), with each of the K (SRI, TPMI, RI) parameter sets including respective SRI, TPMI, and RI values. For example, the K requested values for one or more of the uplink transmission precoding parameters (e.g., the K (SRI, TPMI, RI) parameter sets) may indicate K best values (e.g., the K best (SRI, TPMI, RI) parameter sets) to which to change one or more of the uplink transmission precoding parameters for the CG. In some aspects, the best K values (e.g., the K best (SRI, TPMI, RI) parameter sets) may be determined by the UE 120 based at least in part on measurements of one or more downlink transmissions (e.g., CSI-RSs). In other aspects, the best K values (e.g., the K best (SRI, TPMI, RI) parameter sets) may be determined/predicted by the UE 120 based at least in part on a history of downlink data reception and/or CSI-RS reception using the trained ML model.

As further shown in FIG. 5, and by reference number 530, the network node 110 may transmit, and the UE 120 may receive, an indication of one or more selected uplink transmission precoding parameters for one or more one uplink transmission precoding parameters of the CG to be changed. In some aspects, the network node 110 may select a value for the at least one uplink transmission precoding parameter from the set of requested values indicated for the at least one uplink transmission precoding parameter. In this case, the network node 110 may transmit, and the UE 120 may receive, an indication of the selected value, from the set of requested values, for the at least one uplink transmission precoding parameter. For example, the indication of the selected value may be transmitted to the UE 120 in DCI or a MAC control element (MAC-CE). The at least one uplink transmission precoding parameter may include at least one of the SRI, the TPMI, or the RI. That is, the selected value for the at least one uplink transmission precoding parameter may include a selected value for each of the SRI, the TPMI, and/or the RI. In some aspects, the indication of the selected value may be an indication of a selected (SRI, TPMI, RI) parameter set, from the K requested (SRI, TPMI, RI) parameter sets indicated by the UE 120.

As further shown in FIG. 5, and by reference number 535, the UE 120 may transmit an uplink transmission in a CG occasion associated with the CG using the one or more selected uplink precoding parameters indicated by the network node 110. The network node 110 may receive the uplink transmission in the CG occasion associated with the CG based at least in part on the one or more selected uplink precoding parameters. In some aspects, the network node 110 may transmit the uplink transmission in the CG occasion using the selected value, indicated by the indication received from the network node 110, for the at least one uplink transmission precoding parameter. The at least one uplink transmission precoding parameter may include at least one of the SRI, the TPMI, or the RI. That is, the selected value for the at least one uplink transmission precoding parameter may include a selected value for each of the SRI, the TPMI, and/or the RI. In some aspects, the selected value may be a selected (SRI, TPMI, RI) parameter set, and the UE 120 may transmit the uplink transmission in the CG occasion using the selected (SRI, TPMI, RI) parameter set.

In some aspects, the UE 120 may determine an uplink beam for the uplink transmission in the CG occasions based at least in part on the selected value(s) for one or more of the SRI, the TPMI, or the RI (e.g., the selected (SRI, TPMI, RI) parameter set). In a case in which the selected value(s) do not include selected values for all the of uplink transmission precoding parameters, the UE 120 may determine the uplink beam for the uplink transmission in the CG occasion using the selected value(s) for one or more of the uplink transmission precoding parameters together with the configured value for at least one uplink transmission precoding parameter (for which a selected value is not indicated).

In some aspects, the UE 120 may use the selected value(s) for one or more of the uplink transmission precoding parameters for uplink transmissions a limited number of CG occasions after receiving the indication of the selected value(s). In some aspects, the UE 120 may continue using the selected value(s) for one or more of the uplink transmission precoding parameters in all CG occasions after receiving the indication of the selected value(s) until new value(s) for the one or more of the uplink transmission precoding parameters are received by the UE 120.

As indicated above, FIG. 5 is provided as an example. Other examples may differ from what is described with respect to FIG. 5.

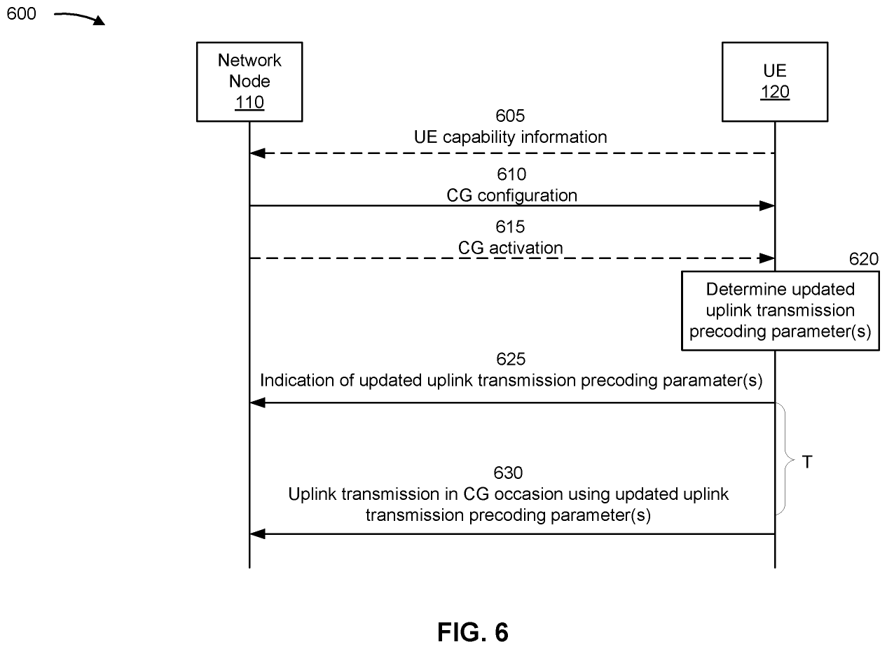

FIG. 6 is a diagram illustrating an example 600 associated with indication of an uplink transmission precoding parameter, in accordance with the present disclosure. As shown in FIG. 6, example 600 includes communication between a network node 110 and a UE 120. In some aspects, the network node 110 and the 120 may be included in a wireless network, such as wireless network 100. The network node 110 and the UE 120 may communicate via a wireless access link, which may include an uplink and a downlink.

As shown in FIG. 6, and by reference number 605, the UE 120 may transmit, and the network node 110 may receive, UE capability information. In some aspects, the UE capability information may indicate a capability of the UE 120 to determine an analog or digital uplink beam. For example, the UE capability information may indicate a capability of the UE 120 to determine a capability of the UE 120 to determine an analog or digital uplink beam over time and/or a capability of the UE 120 to determine an updated uplink beam when beam blocking occurs without CSI-RS reception. In some aspects, the transmission, by the UE 120, of an indication of a change to at least one uplink transmission precoding parameter, described elsewhere herein, may be based at least in part on the UE capability indicated in the UE capability information. For example, in some aspects, the transmission, by the UE 120, of an indication of at least one updated uplink transmission precoding parameter, described below in connection with reference number 625, may be based at least in part on the UE capability indicated in the UE capability information.

As further shown in FIG. 6, and by reference number 610, the network node 110 may transmit, to the UE 120, a CG configuration. The UE 120 may receive the CG configuration transmitted by the network node 110. In some aspects, the network node 110 may transmit, and the UE 120 may receive, configuration information that indicates the CG configuration. For example, the configuration information may indicate a configuration for a CG for the UE 120. In some aspects, the configuration information that indicates the CG configuration may be transmitted to the UE 120 in an RRC message. The CG configuration may configure a CG with periodically recurring uplink resources for CG uplink transmissions. For example, the CG configuration may indicate a resource allocation for transmitting CG uplink transmissions (e.g., in a time domain, frequency domain, spatial domain, and/or code domain) and a periodicity at which the resource allocation is repeated, resulting in periodically reoccurring scheduled CG occasions for the UE 120.

The CG configuration may indicate uplink transmission precoding parameters for the CG uplink transmissions, such as an SRI, a TPMI, and an RI. For example, the CG configuration (e.g., ConfiguredGrantConfig) may include a precodingAndNumberofLayers information element that indicates the TPMI and the RI, and the CG configuration (e.g., ConfiguredGrantConfig) may include an srs-ResourceIndicator information element that indicates the SRI. The CG configured by the CG configuration may be a CG Type 1 (e.g., that does not require activation) or a CG Type 2 (e.g., that is activated via DCI activation). In a case in which the CG is a CG Type 1, the CG configuration may indicate a set of uplink transmission precoding parameters (e.g., SRI, TPMI, and RI) to be used by the UE 120 for the CG uplink transmissions in the CG occasions. In a case in which the CG is a CG Type 2, the CG configuration may indicate multiple sets of uplink transmission precoding parameters (e.g., SRI, TPMI, and RI), and the activation DCI that activates the CG configuration may indicate a set of uplink transmission precoding parameters (e.g., SRI, TPMI, and RI), among the multiple sets of uplink transmission precoding parameters indicated in the CG configuration, to be used by the UE 120 for the CG uplink transmissions in the CG occasions.

As further shown in FIG. 6, and by reference number 615, in some aspects, the network node 110 may transmit, and the UE 120 may receive, a CG activation indication that indicates activation of the CG configured for the UE 120. For example, the network node 110 may transmit, and the UE 120 may receive, CG activation DCI that indicates activation of the CG configured for the UE 120. In some aspects, the network node 110 may transmit the CG activation DCI to the UE 120 to activate the CG configured for the UE 120 in a case in which the CG is a CG Type 2. In this case, the periodic CG occasions for the CG may be activated for the UE 120 based at least in part on the UE 120 receiving the CG activation DCI. In some aspects, the CG activation DCI may indicate a set of uplink transmission precoding parameters (e.g., SRI, TPMI, and RI), among multiple sets of uplink transmission precoding parameters indicated in the CG configuration, to be used by the UE 120 for the CG uplink transmissions in the periodic CG occasions activated by the CG activation DCI.

In some aspects, in a case in which the CG configured for the UE 120 is a CG Type 1, the CG may not require DCI activation. In this case, the network node 110 may not transmit the CG activation indication (e.g., the CG activation DCI) to the UE 120, and the periodic CG occasions for the CG may be activated for the UE 120 based at least in part on the UE 120 receiving the CG configuration, without receiving the CG activation DCI.

Once the CG is activated, the UE 120 may transmit uplink transmissions in the periodic CG occasions associated with the CG. The UE 120 may transmit uplink transmissions in one or more CG occasions associated with the CG using the configured uplink transmission precoding parameters (e.g., SRI, TPMI, and RI) indicated in the CG configuration (e.g., for CG Type 1) and/or the CG activation DCI (e.g., for CG Type 2). For example, the UE 120 may determine an uplink beam (e.g., a precoder matrix) for the uplink transmissions in the CG occasions based at least in part on the configured values of SRI, TPMI, and RI.

As further shown in FIG. 6, and by reference number 620, the UE 120 may determine one or more updated transmission precoding parameters for the CG. The UE 120 may determine an updated value for at least one uplink transmission precoding parameter of the CG. For example, the UE 120 may determine an updated value for at least one of the SRI, the TPMI, or the RI. In some aspects, the UE 120 may determine an updated set of values including updated values for each of the SRI, the TPMI, and the RI. In other aspects, the UE 120 may determine updated value(s) for the SRI and/or the TPMI, while keeping the configured value for the RI. For example, keeping the same value for the RI may enable the network node 110 to better adapt a receive beam used to receive an CG uplink transmission in a case in which the UE 120 autonomously changes the configured uplink transmission precoding parameters to the updated values for the uplink transmission precoding parameters.

In some aspects, the UE 120 may determine updated value(s) for one or more of the uplink transmission precoding parameters for the CG that result in a better uplink beam than a current uplink beam associated with the current uplink transmission precoding parameters. For example, a better uplink beam may be a beam that results in an increase by more than a threshold amount in power (e.g., RSRP) and/or quality (e.g., RSRQ) measurements (e.g., measured or predicted), as compared with the current uplink beam.

In some aspects, the UE 120 may receive, from the network node 110, multiple downlink transmissions including CSI-RSs for the purpose of uplink TPMI determination. For example, the CSI-RSs may include periodic CSI-RS transmissions. The UE 120 may perform measurements (e.g., RSRP and/or RSRQ measurements) on the downlink transmissions (e.g., the CSI-RSs), and the UE 120 may determine an uplink TPMI based at least in part on the measurements. In this case, the UE 120 may determine an updated value for the TPMI that is different from the current TPMI value (e.g., the configured TPMI value) for the CG based at least in part on one or more measurements (e.g., RSRP and/or RSRQ measurements) performed on one or more downlink transmissions (e.g., one or more CSI-RSs) received by the UE 120. For example, the UE 120 may determine an updated value for the TPMI that corresponds to a best uplink beam for uplink transmissions to the network node 110, based at least in part on the measurements performed on the one or more downlink transmissions (e.g., CSI-RSs). Additionally, or alternatively, the UE 120 may determine an updated value for the SRI and/or an updated value for the RI based at least in part on the measurements performed on the one or more downlink transmissions (e.g., CSI-RSs).

In some aspects, the UE 120 may determine/predict an updated TPMI that is different/distinct from the current TPMI (e.g., the configured TPMI) for the CG without receiving and/or measuring CSI-RSs based at least in part on an ML model and a set of training data. For example, the UE 120 may include (e.g., be configured with) the ML model, and the ML model may be trained using the set of training data. The UE 120 may use the ML model to predict, based at least in part on a history of data reception and/or CSI-RS reception for the UE 120, an updated value for the TPMI that results in a best uplink beam for uplink transmissions to the network node 110. Additionally, and/or alternatively, the UE 120 may use the ML model to predict, based at least in part on the history of data reception and/or CSI-RS reception for the UE 120, an updated value for the SRI and/or an updated value for the RI that results in the best uplink beam for uplink transmissions to the network node 110.

In some aspects, the UE 120 may determine to change at least one uplink transmission precoding parameter for the CG to an updated value based at least in part on a determination, by the UE 120, that the updated value for the at least one uplink transmission precoding parameter results in a better uplink beam than the current uplink beam associated with the current uplink transmission precoding parameters. In some aspects, the UE 120 may determine to change at least one uplink transmission precoding parameter for the CG (e.g., at least one of the SRI, the TPMI, or the RI for the CG) in connection with detecting or determining that a beam blockage has occurred or in connection with detecting or determining a mobility event associated with the UE 120. In this case, the UE 120 may determine the updated value for the at least one uplink transmission precoding parameter based at least in part on the determination to change the at least one uplink transmission precoding parameter in connection with detecting or determining the beam blockage or the mobility event.

As further shown in FIG. 6, and by reference number 625, the UE 120 may transmit, and the network node 110 may receive, an indication of the one or more updated uplink transmission precoding parameter(s) for the CG. In some aspects, the UE 120 may transmit, and the network node 110 may receive, an indication of the updated value, determined by the UE 120, for at least one uplink transmission precoding parameter for the CG. In this case, the updated value for the at least one uplink transmission precoding parameter may provide, to the network node 110, an indication of a change to the at least one uplink transmission precoding parameter of the CG. In some aspects, the UE 120 may transmit the indication of the updated value for the at least one uplink transmission precoding parameter in uplink control information (UCI). In some aspects, the indication (e.g., in the UCI) of the updated value for the at least one uplink transmission precoding parameter may be an indication of an (SRI, TPMI, RI) parameter set that includes updated value(s) for the SRI, the TPMI, and/or the RI. In some aspects, the indication (e.g., in the UCI) of the updated value for the at least one uplink transmission precoding parameter may include an indication of an updated value for the TPMI and/or an indication of an updated value for the SRI.

In some aspects, the UE 120 may transmit the UCI including the indication of the updated value for the at least one uplink transmission precoding parameter in an uplink resource configured for transmission of UCI. For example, the UE 120 may be configured with periodic uplink resources for transmitting the UCI, and the UE 120 may transmit the UCI including the indication of the updated value for the at least one uplink transmission precoding parameter in an uplink resource of the periodic uplink resources for transmitting the UCI. In this case, the network node 110 may transmit (e.g., in an RRC message), and the UE 120 may receive, the configuration of the periodic uplink resources for transmitting the UCI. For example, the configuration of the periodic uplink resources for transmitting the UCI may be included in the CG configuration (e.g., the configuration information for the CG) or in other configuration information received by the UE 120 from the network node 110. In some aspects, the periodic uplink resources in which the UE 120 transmits the UCI may be periodic uplink resources configured for transmitting the UCI that indicates the updated value for at least one uplink transmission precoding parameter of the CG. In other aspects, the periodic uplink resources in which the UE 120 transmits the UCI may be periodic uplink resources configured for any UCI transmissions by the UE 120.

In some aspects, the periodic uplink resources may be associated with the CG or a group of CGs (e.g., including the CG) configured for the UE 120. For example, for each CG configured for the UE 120, the network node 110 may allocate (e.g., configure the UE 120 with) a respective uplink resource associated with the CG to be used for transmitting the UCI that indicates updated value(s) for one or more uplink transmission precoding parameters for the CG. In this case, the respective uplink resource associated with the CG may be configured (e.g., in the configuration information for the CG) with the same periodicity as the CG. In another example, for each group of CGs configured for the UE 120, the network node 110 may allocate (e.g., configure the UE 120 with) a respective uplink resource associated with the group of CGs to be used for transmitting the UCI that indicates updated value(s) for one or more uplink transmission precoding parameters for a CG in the group of CGs. In this case, the respective uplink resource associated with the group of CGs may be configured (e.g., in the configuration information for the group of CGs) with the same periodicity as one or more of the CGs in the group of CGs.

In some aspects, the UE 120 may indicate, in the UCI that includes the indication of the updated value for at least one uplink transmission precoding parameter of the CG, that the updated value for the at least one uplink transmission precoding parameter is to be applied for multiple CG occasions of the CG. For example, the UCI may include a bit that is set to a first value (e.g., 1) to indicate that the updated value for the at least one uplink transmission precoding parameter is to be applied for multiple CG occasions of the CG, or a second value (e.g., 0) to indicate that the updated value for the at least one uplink transmission precoding parameter is not to be applied for multiple CG occasions of the CG.

In some aspects, the UE 120 may indicate, in the UCI that includes the indication of the updated value for at least one uplink transmission precoding parameter of the CG, that the updated value for the at least one uplink transmission precoding parameter is to be applied for multiple CGs configured for the UE 120. For example, the UCI may include a bit that is set to a first value (e.g., 1) to indicate that the updated value for the at least one uplink transmission precoding parameter is to be applied for multiple CGs configured for the UE 120, or a second value (e.g., 0) to indicate that the updated value for the at least one uplink transmission precoding parameter is not to be applied for multiple CGs configured for the UE 120. This reduces signaling overhead for indicating the same updated values for uplink transmission precoding parameters for multiple CGs configured for the UE 120.

As further shown in FIG. 6, and by reference number 630, the UE 120 may transmit an uplink transmission in a CG occasion associated with the CG using the one or more updated uplink transmission precoding parameters. In some aspects, the UE 120 may autonomously switch to using the updated value, determined by the UE 120, for at least one uplink transmission precoding parameter (e.g., the SRI, TPMI, and/or the RI) after an activation time duration T from transmitting the indication of the updated value for the at least one uplink transmission precoding parameter to the network node 110. For example, the UE 120 may transmit an uplink transmission using the updated value for the at least one uplink transmission precoding parameter for the CG starting in a first CG occasion after the activation time duration T from transmitting the indication of the updated value for the at least one uplink transmission precoding parameter. In some aspects, the activation time duration T may be expressed as an amount of time (e.g., in seconds or milliseconds) or a number of slots or symbols. In some aspects, the UE 120 may continue using the previous values (e.g., the configured values) for the uplink transmission precoding parameters for the CG for transmitting an uplink communication in a CG occasion that occurs within the activation time duration T from transmitting the indication of the updated value for the at least one uplink transmission precoding parameter.

In some aspects, the UE 120 may determine an uplink beam for the uplink transmission in the CG occasion after the activation time duration T from transmitting the indication of the updated value for the at least one uplink transmission precoding parameter based at least in part on the updated value for the at least one uplink transmission precoding parameter (e.g., the updated value(s) for the SRI, the TPMI, and/or the RI). In a case in which updated value(s) do not include updated values for all of the uplink transmission precoding parameters, the UE 120 may determine the uplink beam for the uplink transmission in the CG occasion using the updated value(s) for one or more of the uplink transmission precoding parameters together with the configured value for at least one uplink transmission precoding parameter (for which an updated value is not determined or indicated by the UE 120).

The network node 110 may receive the uplink transmission in a CG occasion after the activation time duration T from receiving the indication of the updated value for the at least one uplink transmission precoding parameter based at least in part on the updated value for the at least one uplink transmission precoding parameter. In some aspects, the network node 110 may adapt a receive beam used to receive the uplink transmission in the CG occasion based at least in part on the updated value for the at least one uplink transmission precoding parameter. For example, the network node 110 may select a corresponding receive beam (e.g., a best receive beam for the uplink transmit beam used by the UE 120) based at least in part on the SRI, TPMI, and RI used by the UE 120 for the uplink transmission (e.g., the SRI, TPMI, and RI with one or more updated values as compared to the configured values for the CG).

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with indication of uplink transmission precoding parameter change.

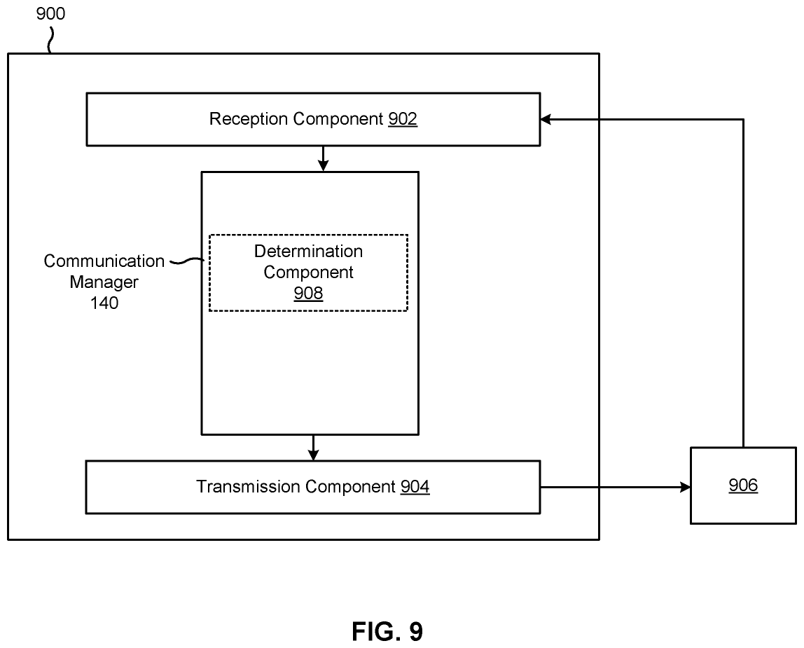

As shown in FIG. 7, in some aspects, process 700 may include receiving, from a network node, configuration information for a configured grant, the configuration information indicating one or more uplink transmission precoding parameters for the configured grant (block 710). For example, the UE (e.g., using communication manager 140 and/or reception component 902, depicted in FIG. 9) may receive, from a network node, configuration information for a configured grant, the configuration information indicating one or more uplink transmission precoding parameters for the configured grant, as described above.

As further shown in FIG. 7, in some aspects, process 700 may include transmitting, to the network node, an indication of a change to at least one uplink transmission precoding parameter of the one or more uplink transmission precoding parameters for the configured grant (block 720). For example, the UE (e.g., using communication manager 140 and/or transmission component 904, depicted in FIG. 9) may transmit, to the network node, an indication of a change to at least one uplink transmission precoding parameter of the one or more uplink transmission precoding parameters for the configured grant, as described above.

As further shown in FIG. 7, in some aspects, process 700 may include transmitting, to the network node, an uplink transmission in a configured grant occasion associated with the configured grant with the at least one uplink transmission precoding parameter based at least in part on the indication of the change to the at least one uplink transmission precoding parameter (block 730). For example, the UE (e.g., using communication manager 140 and/or transmission component 904, depicted in FIG. 9) may transmit, to the network node, an uplink transmission in a configured grant occasion associated with the configured grant with the at least one uplink transmission precoding parameter based at least in part on the indication of the change to the at least one uplink transmission precoding parameter, as described above.

Process 700 may include additional aspects, such as any single aspect or any combination of aspects described below and/or in connection with one or more other processes described elsewhere herein.

In a first aspect, the indication of the change indicates a change to at least one of an SRI, a TPMI, or an RI.

In a second aspect, alone or in combination with the first aspect, the indication of the change indicates a set of values including an SRI value, a TPMI value, and an RI value.

In a third aspect, alone or in combination with one or more of the first and second aspects, process 700 includes transmitting, to the network node, UE capability information indicating a capability of the UE to determine an analog or digital uplink beam, wherein transmitting the indication of the change to the at least one uplink transmission precoding parameter is based at least in part on the UE capability information.

In a fourth aspect, alone or in combination with one or more of the first through third aspects, transmitting the indication of the change to the at least one uplink transmission precoding parameter includes transmitting an indication of a set of requested values for the at least one uplink transmission precoding parameter.

In a fifth aspect, alone or in combination with one or more of the first through fourth aspects, process 700 includes receiving, from the network node, a selected value, from the set of requested values, for the at least one uplink transmission precoding parameter, wherein transmitting the uplink transmission includes transmitting the uplink transmission using the selected value for the at least one uplink transmission precoding parameter.

In a sixth aspect, alone or in combination with one or more of the first through fifth aspects, transmitting the indication of the set of requested values for the at least one uplink transmission precoding parameter includes transmitting the indication of the set of requested values for the at least one uplink transmission precoding parameter in an uplink CSI report.

In a seventh aspect, alone or in combination with one or more of the first through sixth aspects, the indication of the change to the at least one uplink transmission precoding parameter indicates an updated value for the at least one uplink transmission precoding parameter, and transmitting the uplink transmission includes transmitting the uplink transmission using the updated value for the at least one uplink transmission precoding parameter.

In an eighth aspect, alone or in combination with one or more of the first through seventh aspects, transmitting the uplink transmission using the update value for the at least one uplink transmission precoding parameter includes transmitting the uplink transmission using the updated value for the at least one uplink transmission precoding parameter after an activation time duration from transmitting the indication of the change to the at least one uplink transmission precoding parameter.

In a ninth aspect, alone or in combination with one or more of the first through eighth aspects, transmitting the indication of the change to the at least one uplink transmission precoding parameter includes transmitting UCI that indicates the updated value for the at least one uplink transmission precoding parameter.

In a tenth aspect, alone or in combination with one or more of the first through ninth aspects, process 700 includes receiving, from the network node, a configuration of periodic uplink resources for transmitting the UCI that indicates the updated value for the at least one uplink transmission precoding parameter, wherein transmitting the UCI that indicates the updated value for the at least one uplink transmission precoding parameter includes transmitting the UCI in an uplink resource of the periodic uplink resources.

In an eleventh aspect, alone or in combination with one or more of the first through tenth aspects, the configuration of the periodic uplink resources is included in the configuration information for the configured grant, and a periodicity of the periodic uplink resources is a periodicity of the configured grant.

In a twelfth aspect, alone or in combination with one or more of the first through eleventh aspects, the indication of the change to the at least one uplink transmission precoding parameter further indicates that the updated value for the at least one uplink transmission precoding parameter is to be applied to multiple configured grant occasions associated with the configured grant.

In a thirteenth aspect, alone or in combination with one or more of the first through twelfth aspects, the indication of the change to the at least one uplink transmission precoding parameter further indicates that the updated value for the at least one uplink transmission precoding parameter is to be applied to multiple configured grants configured for the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with indication of uplink transmission precoding parameter change.

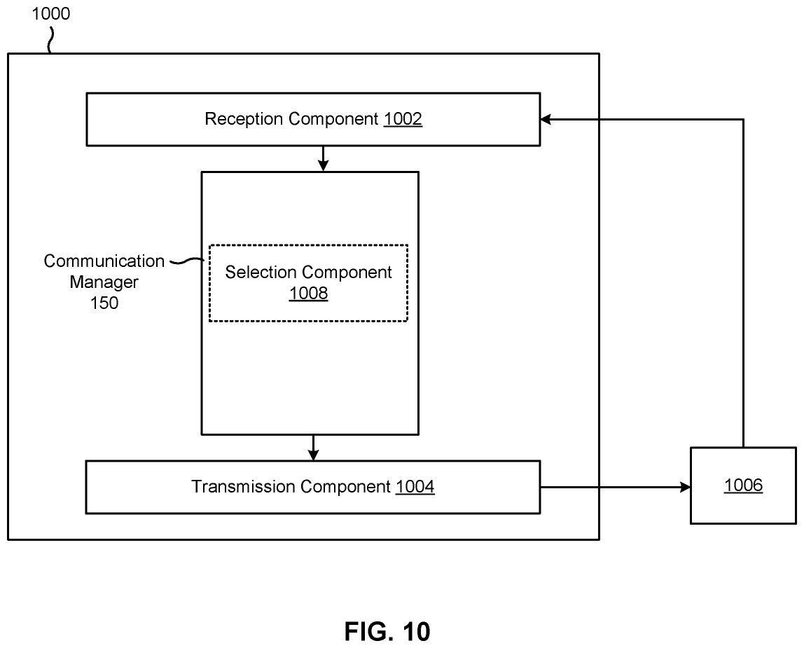

As shown in FIG. 8, in some aspects, process 800 may include transmitting, to a UE, configuration information for a configured grant, the configuration information indicating one or more uplink transmission precoding parameters for the configured grant (block 810). For example, the network node (e.g., using communication manager 150 and/or transmission component 1004, depicted in FIG. 10) may transmit, to a UE, configuration information for a configured grant, the configuration information indicating one or more uplink transmission precoding parameters for the configured grant, as described above.

As further shown in FIG. 8, in some aspects, process 800 may include receiving, from the UE, an indication of a change to at least one uplink transmission precoding parameter of the one or more uplink transmission precoding parameters for the configured grant (block 820). For example, the network node (e.g., using communication manager 150 and/or reception component 1002, depicted in FIG. 10) may receive, from the UE, an indication of a change to at least one uplink transmission precoding parameter of the one or more uplink transmission precoding parameters for the configured grant, as described above.

As further shown in FIG. 8, in some aspects, process 800 may include receiving, from the UE, an uplink transmission in a configured grant occasion associated with the configured grant with the at least one uplink transmission precoding parameter based at least in part on the indication of the change to the at least one uplink transmission precoding parameter (block 830). For example, the network node (e.g., using communication manager 150 and/or reception component 1002, depicted in FIG. 10) may receive, from the UE, an uplink transmission in a configured grant occasion associated with the configured grant with the at least one uplink transmission precoding parameter based at least in part on the indication of the change to the at least one uplink transmission precoding parameter, as described above.

Process 800 may include additional aspects, such as any single aspect or any combination of aspects described below and/or in connection with one or more other processes described elsewhere herein.

In a first aspect, the indication of the change indicates a change to at least one of an SRI, a TPMI, or an RI.

In a second aspect, alone or in combination with the first aspect, the indication of the change indicates a set of values including an SRI value, a TPMI value, and an RI value.

In a third aspect, alone or in combination with one or more of the first and second aspects, process 800 includes receiving UE capability information indicating a capability of the UE to determine an analog or digital uplink beam.

In a fourth aspect, alone or in combination with one or more of the first through third aspects, receiving the indication of the change to the at least one uplink transmission precoding parameter includes receiving an indication of a set of requested values for the at least one uplink transmission precoding parameter.

In a fifth aspect, alone or in combination with one or more of the first through fourth aspects, process 800 includes transmitting, to the UE, a selected value, from the set of requested values, for the at least one uplink transmission precoding parameter.

In a sixth aspect, alone or in combination with one or more of the first through fifth aspects, receiving the indication of the set of requested values for the at least one uplink transmission precoding parameter includes receiving the indication of the set of requested values for the at least one uplink transmission precoding parameter in an uplink CSI report.

In a seventh aspect, alone or in combination with one or more of the first through sixth aspects, the indication of the change to the at least one uplink transmission precoding parameter indicates an updated value for the at least one uplink transmission precoding parameter, and receiving the uplink transmission includes receiving the uplink transmission based at least in part on the updated value for the at least one uplink transmission precoding parameter.

In an eighth aspect, alone or in combination with one or more of the first through seventh aspects, receiving the uplink transmission based at least in part on the updated value for the at least one uplink transmission precoding parameter includes receiving the uplink transmission based at least in part on the updated value for the at least one uplink transmission precoding parameter after an activation time duration from receiving the indication of the change to the at least one uplink transmission precoding parameter.

In a ninth aspect, alone or in combination with one or more of the first through eighth aspects, receiving the indication of the change to the at least one uplink transmission precoding parameter includes receiving UCI that indicates the updated value for the at least one uplink transmission precoding parameter.

In a tenth aspect, alone or in combination with one or more of the first through ninth aspects, process 800 includes transmitting, to the UE, a configuration of periodic uplink resources for transmitting the UCI that indicates the updated value for the at least one uplink transmission precoding parameter, wherein receiving the UCI that indicates the updated value for the at least one uplink transmission precoding parameter includes receiving the UCI in an uplink resource of the periodic uplink resources.

In an eleventh aspect, alone or in combination with one or more of the first through tenth aspects, the configuration of the periodic uplink resources is included in the configuration information for the configured grant, and a periodicity of the periodic uplink resources is a periodicity of the configured grant.

In a twelfth aspect, alone or in combination with one or more of the first through eleventh aspects, the indication of the change to the at least one uplink transmission precoding parameter further indicates that the updated value for the at least one uplink transmission precoding parameter is to be applied to multiple configured grant occasions associated with the configured grant.

In a thirteenth aspect, alone or in combination with one or more of the first through twelfth aspects, the indication of the change to the at least one uplink transmission precoding parameter further indicates that the updated value for the at least one uplink transmission precoding parameter is to be applied to multiple configured grants configured for the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a determination component 908, among other examples.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network node, configuration information for a configured grant, the configuration information indicating one or more uplink transmission precoding parameters for the configured grant. The transmission component 904 may transmit, to the network node, an indication of a change to at least one uplink transmission precoding parameter of the one or more uplink transmission precoding parameters for the configured grant. The transmission component 904 may transmit, to the network node, an uplink transmission in a configured grant occasion associated with the configured grant with the at least one uplink transmission precoding parameter based at least in part on the indication of the change to the at least one uplink transmission precoding parameter.

The transmission component 904 may transmit, to the network node, UE capability information indicating a capability of the UE to determine an analog or digital uplink beam, wherein transmitting the indication of the change to the at least one uplink transmission precoding parameter is based at least in part on the UE capability information.

The reception component 902 may receive, from the network node, a selected value, from the set of requested values, for the at least one uplink transmission precoding parameter, wherein transmitting the uplink transmission comprises transmitting the uplink transmission using the selected value for the at least one uplink transmission precoding parameter.

The determination component 908 may determine an updated value for the at least one uplink transmission precoding parameter.

The reception component 902 may receive, from the network node, a configuration of periodic uplink resources for transmitting the UCI that indicates the updated value for the at least one uplink transmission precoding parameter, wherein transmitting the UCI that indicates the updated value for the at least one uplink transmission precoding parameter comprises transmitting the UCI in an uplink resource of the periodic uplink resources.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a selection component 1008, among other examples.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit, to a UE, configuration information for a configured grant, the configuration information indicating one or more uplink transmission precoding parameters for the configured grant. The reception component 1002 may receive, from the UE, an indication of a change to at least one uplink transmission precoding parameter of the one or more uplink transmission precoding parameters for the configured grant. The reception component 1002 may receive, from the UE, an uplink transmission in a configured grant occasion associated with the configured grant with the at least one uplink transmission precoding parameter based at least in part on the indication of the change to the at least one uplink transmission precoding parameter.

The reception component 1002 may receive UE capability information indicating a capability of the UE to determine an analog or digital uplink beam.

The transmission component 1004 may transmit, to the UE, a selected value, from the set of requested values, for the at least one uplink transmission precoding parameter.

The selection component 1008 may select the selected value, from the set of requested values, for the at least one uplink transmission precoding parameter.

The transmission component 1004 may transmit, to the UE, a configuration of periodic uplink resources for transmitting the UCI that indicates the updated value for the at least one uplink transmission precoding parameter, wherein receiving the UCI that indicates the updated value for the at least one uplink transmission precoding parameter comprises receiving the UCI in an uplink resource of the periodic uplink resources.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, from a network node, configuration information for a configured grant, the configuration information indicating one or more uplink transmission precoding parameters for the configured grant; transmitting, to the network node, an indication of a change to at least one uplink transmission precoding parameter of the one or more uplink transmission precoding parameters for the configured grant; and transmitting, to the network node, an uplink transmission in a configured grant occasion associated with the configured grant with the at least one uplink transmission precoding parameter based at least in part on the indication of the change to the at least one uplink transmission precoding parameter.

Aspect 2: The method of Aspect 1, wherein the indication of the change indicates a change to at least one of a sounding reference signal (SRS) resource indicator (SRI), a transmit precoder matrix indicator (TPMI), or a rank indicator (RI).

Aspect 3: The method of Aspect 2, wherein the indication of the change indicates a set of values including an SRI value, a TPMI value, and an RI value.

Aspect 4: The method of any of Aspects 1-3, further comprising: transmitting, to the network node, UE capability information indicating a capability of the UE to determine an analog or digital uplink beam, wherein transmitting the indication of the change to the at least one uplink transmission precoding parameter is based at least in part on the UE capability information.

Aspect 5: The method of any of Aspects 1-4, wherein transmitting the indication of the change to the at least one uplink transmission precoding parameter comprises: transmitting an indication of a set of requested values for the at least one uplink transmission precoding parameter.

Aspect 6: The method of Aspect 5, further comprising: receiving, from the network node, a selected value, from the set of requested values, for the at least one uplink transmission precoding parameter, wherein transmitting the uplink transmission comprises transmitting the uplink transmission using the selected value for the at least one uplink transmission precoding parameter.

Aspect 7: The method of any of Aspects 5-6, wherein transmitting the indication of the set of requested values for the at least one uplink transmission precoding parameter comprises: transmitting the indication of the set of requested values for the at least one uplink transmission precoding parameter in an uplink channel state information (CSI) report.

Aspect 8: The method of any of Aspects 1-7, wherein the indication of the change to the at least one uplink transmission precoding parameter indicates an updated value for the at least one uplink transmission precoding parameter, and wherein transmitting the uplink transmission comprises: transmitting the uplink transmission using the updated value for the at least one uplink transmission precoding parameter.

Aspect 9: The method of Aspect 8, wherein transmitting the uplink transmission using the update value for the at least one uplink transmission precoding parameter comprises: transmitting the uplink transmission using the updated value for the at least one uplink transmission precoding parameter after an activation time duration from transmitting the indication of the change to the at least one uplink transmission precoding parameter.

Aspect 10: The method of any of Aspects 8-9, wherein transmitting the indication of the change to the at least one uplink transmission precoding parameter comprises: transmitting uplink control information (UCI) that indicates the updated value for the at least one uplink transmission precoding parameter.

Aspect 11: The method of Aspect 10, further comprising: receiving, from the network node, a configuration of periodic uplink resources for transmitting the UCI that indicates the updated value for the at least one uplink transmission precoding parameter, wherein transmitting the UCI that indicates the updated value for the at least one uplink transmission precoding parameter comprises transmitting the UCI in an uplink resource of the periodic uplink resources.

Aspect 12: The method of Aspect 11, wherein the configuration of the periodic uplink resources is included in the configuration information for the configured grant, and wherein a periodicity of the periodic uplink resources is a periodicity of the configured grant.

Aspect 13: The method of any of Aspects 8-12, wherein the indication of the change to the at least one uplink transmission precoding parameter further indicates that the updated value for the at least one uplink transmission precoding parameter is to be applied to multiple configured grant occasions associated with the configured grant.

Aspect 14: The method of any of Aspects 8-13, wherein the indication of the change to the at least one uplink transmission precoding parameter further indicates that the updated value for the at least one uplink transmission precoding parameter is to be applied to multiple configured grants configured for the UE.

Aspect 15: A method of wireless communication performed by a network node, comprising: transmitting, to a user equipment (UE), configuration information for a configured grant, the configuration information indicating one or more uplink transmission precoding parameters for the configured grant; receiving, from the UE, an indication of a change to at least one uplink transmission precoding parameter of the one or more uplink transmission precoding parameters for the configured grant; and receiving, from the UE, an uplink transmission in a configured grant occasion associated with the configured grant with the at least one uplink transmission precoding parameter based at least in part on the indication of the change to the at least one uplink transmission precoding parameter.

Aspect 16: The method of Aspect 15, wherein the indication of the change indicates a change to at least one of a sounding reference signal (SRS) resource indicator (SRI), a transmit precoder matrix indicator (TPMI), or a rank indicator (RI).

Aspect 17: The method of Aspect 16, wherein the indication of the change indicates a set of values including an SRI value, a TPMI value, and an RI value.

Aspect 18: The method of any of Aspects 15-17, further comprising: receiving UE capability information indicating a capability of the UE to determine an analog or digital uplink beam.

Aspect 19: The method of any of Aspects 15-18, wherein receiving the indication of the change to the at least one uplink transmission precoding parameter comprises: receiving an indication of a set of requested values for the at least one uplink transmission precoding parameter.

Aspect 20: The method of Aspect 19, further comprising: transmitting, to the UE, a selected value, from the set of requested values, for the at least one uplink transmission precoding parameter.

Aspect 21: The method of any of Aspects 19-20, wherein receiving the indication of the set of requested values for the at least one uplink transmission precoding parameter comprises: receiving the indication of the set of requested values for the at least one uplink transmission precoding parameter in an uplink channel state information (CSI) report.

Aspect 22: The method of any of Aspects 15-21, wherein the indication of the change to the at least one uplink transmission precoding parameter indicates an updated value for the at least one uplink transmission precoding parameter, and wherein receiving the uplink transmission comprises: receiving the uplink transmission based at least in part on the updated value for the at least one uplink transmission precoding parameter.

Aspect 23: The method of Aspect 22, wherein receiving the uplink transmission based at least in part on the updated value for the at least one uplink transmission precoding parameter comprises: receiving the uplink transmission based at least in part on the updated value for the at least one uplink transmission precoding parameter after an activation time duration from receiving the indication of the change to the at least one uplink transmission precoding parameter.

Aspect 24: The method of any of Aspects 22-23, wherein receiving the indication of the change to the at least one uplink transmission precoding parameter comprises: receiving uplink control information (UCI) that indicates the updated value for the at least one uplink transmission precoding parameter.

Aspect 25: The method of Aspect 24, further comprising: transmitting, to the UE, a configuration of periodic uplink resources for transmitting the UCI that indicates the updated value for the at least one uplink transmission precoding parameter, wherein receiving the UCI that indicates the updated value for the at least one uplink transmission precoding parameter comprises receiving the UCI in an uplink resource of the periodic uplink resources.

Aspect 26: The method of Aspect 25, wherein the configuration of the periodic uplink resources is included in the configuration information for the configured grant, and wherein a periodicity of the periodic uplink resources is a periodicity of the configured grant.

Aspect 27: The method of any of Aspects 22-26, wherein the indication of the change to the at least one uplink transmission precoding parameter further indicates that the updated value for the at least one uplink transmission precoding parameter is to be applied to multiple configured grant occasions associated with the configured grant.

Aspect 28: The method of any of Aspects 22-27, wherein the indication of the change to the at least one uplink transmission precoding parameter further indicates that the updated value for the at least one uplink transmission precoding parameter is to be applied to multiple configured grants configured for the UE.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network node, configuration information for a configured grant, the configuration information indicating one or more uplink transmission precoding parameters for the configured grant;
transmit, to the network node, an indication of a change to at least one uplink transmission precoding parameter of the one or more uplink transmission precoding parameters for the configured grant; and
transmit, to the network node, an uplink transmission in a configured grant occasion associated with the configured grant with the at least one uplink transmission precoding parameter based at least in part on the indication of the change to the at least one uplink transmission precoding parameter.

2. The UE of claim 1, wherein the indication of the change indicates a change to at least one of a sounding reference signal (SRS) resource indicator (SRI), a transmit precoder matrix indicator (TPMI), or a rank indicator (RI).

3. The UE of claim 2, wherein the indication of the change indicates a set of values including an SRI value, a TPMI value, and an RI value.

4. The UE of claim 1, wherein the one or more processors are further configured to:
transmit, to the network node, UE capability information indicating a capability of the UE to determine an analog or digital uplink beam.

5. The UE of claim 1, wherein the one or more processors, to transmit the indication of the change to the at least one uplink transmission precoding parameter, are configured to:
transmit an indication of a set of requested values for the at least one uplink transmission precoding parameter.

6. The UE of claim 5, wherein the one or more processors are further configured to:
receive, from the network node, a selected value, from the set of requested values, for the at least one uplink transmission precoding parameter, wherein transmitting the uplink transmission comprises transmitting the uplink transmission using the selected value for the at least one uplink transmission precoding parameter.

7. The UE of claim 5, wherein the one or more processors, to transmit the indication of the set of requested values for the at least one uplink transmission precoding parameter, are configured to:
transmit the indication of the set of requested values for the at least one uplink transmission precoding parameter in an uplink channel state information (CSI) report.

8. The UE of claim 1, wherein the indication of the change to the at least one uplink transmission precoding parameter indicates an updated value for the at least one uplink transmission precoding parameter, and wherein the one or more processors, to transmit the uplink transmission, are configured to:
transmit the uplink transmission using the updated value for the at least one uplink transmission precoding parameter.

9. The UE of claim 8, wherein the one or more processors, to transmit the uplink transmission using the update value for the at least one uplink transmission precoding parameter, are configured to:
transmit the uplink transmission using the updated value for the at least one uplink transmission precoding parameter after an activation time duration from the indication of the change to the at least one uplink transmission precoding parameter.

10. The UE of claim 8, wherein the one or more processors, to transmit the indication of the change to the at least one uplink transmission precoding parameter, are configured to:
transmit uplink control information (UCI) that indicates the updated value for the at least one uplink transmission precoding parameter.

11. The UE of claim 10, wherein the one or more processors are further configured to:
receive, from the network node, a configuration of periodic uplink resources for transmitting the UCI that indicates the updated value for the at least one uplink transmission precoding parameter, wherein the one or more processors, to transmit the UCI that indicates the updated value for the at least one uplink transmission precoding parameter, are configured to transmit the UCI in an uplink resource of the periodic uplink resources.

12. The UE of claim 11, wherein the configuration of the periodic uplink resources is included in the configuration information for the configured grant, and wherein a periodicity of the periodic uplink resources is a periodicity of the configured grant.

13. The UE of claim 8, wherein the indication of the change to the at least one uplink transmission precoding parameter further indicates that the updated value for the at least one uplink transmission precoding parameter is to be applied to multiple configured grant occasions associated with the configured grant.

14. The UE of claim 8, wherein the indication of the change to the at least one uplink transmission precoding parameter further indicates that the updated value for the at least one uplink transmission precoding parameter is to be applied to multiple configured grants configured for the UE.

15. A network node for wireless communication, comprising:
a memory; and
one or more processors, coupled to the memory, configured to:
transmit, to a user equipment (UE), configuration information for a configured grant, the configuration information indicating one or more uplink transmission precoding parameters for the configured grant;
receive, from the UE, an indication of a change to at least one uplink transmission precoding parameter of the one or more uplink transmission precoding parameters for the configured grant; and
receive, from the UE, an uplink transmission in a configured grant occasion associated with the configured grant with the at least one uplink transmission precoding parameter based at least in part on the indication of the change to the at least one uplink transmission precoding parameter.

16. The network node of claim 15, wherein the indication of the change indicates a change to at least one of a sounding reference signal (SRS) resource indicator (SRI), a transmit precoder matrix indicator (TPMI), or a rank indicator (RI).

17. The network node of claim 16, wherein the indication of the change indicates a set of values including an SRI value, a TPMI value, and an RI value.

18. The network node of claim 15, wherein the one or more processors, to receive the indication of the change to the at least one uplink transmission precoding parameter, are configured to receive an indication of a set of requested values for the at least one uplink transmission precoding parameter, and wherein the one or more processors are further configured to:
transmit, to the UE, a selected value, from the set of requested values, for the at least one uplink transmission precoding parameter.

19. The network node of claim 15, wherein the indication of the change to the at least one uplink transmission precoding parameter indicates an updated value for the at least one uplink transmission precoding parameter, and wherein the one or more processors, to receive the uplink transmission, are configured to:
receive the uplink transmission based at least in part on the updated value for the at least one uplink transmission precoding parameter after an activation time duration from the indication of the change to the at least one uplink transmission precoding parameter.

20. The network node of claim 19, wherein the one or more processors, to receive the indication of the change to the at least one uplink transmission precoding parameter, are configured to:
receive uplink control information (UCI) that indicates the updated value for the at least one uplink transmission precoding parameter.

21. A method of wireless communication performed by a user equipment (UE), comprising:
receiving, from a network node, configuration information for a configured grant, the configuration information indicating one or more uplink transmission precoding parameters for the configured grant;
transmitting, to the network node, an indication of a change to at least one uplink transmission precoding parameter of the one or more uplink transmission precoding parameters for the configured grant; and
transmitting, to the network node, an uplink transmission in a configured grant occasion associated with the configured grant with the at least one uplink transmission precoding parameter based at least in part on the indication of the change to the at least one uplink transmission precoding parameter.

22. The method of claim 21, wherein the indication of the change indicates a change to at least one of a sounding reference signal (SRS) resource indicator (SRI), a transmit precoder matrix indicator (TPMI), or a rank indicator (RI).

23. The method of claim 22, wherein the indication of the change indicates a set of values including an SRI value, a TPMI value, and an RI value.

24. The method of claim 21, wherein transmitting the indication of the change to the at least one uplink transmission precoding parameter comprises:
transmitting an indication of a set of requested values for the at least one uplink transmission precoding parameter.

25. The method of claim 24, further comprising:
receiving, from the network node, a selected value, from the set of requested values, for the at least one uplink transmission precoding parameter, wherein transmitting the uplink transmission comprises transmitting the uplink transmission using the selected value for the at least one uplink transmission precoding parameter.

26. The method of claim 21, wherein the indication of the change to the at least one uplink transmission precoding parameter indicates an updated value for the at least one uplink transmission precoding parameter, and wherein transmitting the uplink transmission comprises:
transmitting the uplink transmission using the updated value for the at least one uplink transmission precoding parameter after an activation time duration from transmitting the indication of the change to the at least one uplink transmission precoding parameter.

27. A method of wireless communication performed by a network node, comprising:
transmitting, to a user equipment (UE), configuration information for a configured grant, the configuration information indicating one or more uplink transmission precoding parameters for the configured grant;
receiving, from the UE, an indication of a change to at least one uplink transmission precoding parameter of the one or more uplink transmission precoding parameters for the configured grant; and
receiving, from the UE, an uplink transmission in a configured grant occasion associated with the configured grant with the at least one uplink transmission precoding parameter based at least in part on the indication of the change to the at least one uplink transmission precoding parameter.

28. The method of claim 27, wherein the indication of the change indicates a change to at least one of a sounding reference signal (SRS) resource indicator (SRI), a transmit precoder matrix indicator (TPMI), or a rank indicator (RI).

29. The method of claim 27, wherein receiving the indication of the change to the at least one uplink transmission precoding parameter comprises receiving an indication of a set of requested values for the at least one uplink transmission precoding parameter, and further comprising:
transmitting, to the UE, a selected value, from the set of requested values, for the at least one uplink transmission precoding parameter.

30. The method of claim 27, wherein the indication of the change to the at least one uplink transmission precoding parameter indicates an updated value for the at least one uplink transmission precoding parameter, and wherein receiving the uplink transmission comprises:
receiving the uplink transmission based at least in part on the updated value for the at least one uplink transmission precoding parameter after an activation time duration from receiving the indication of the change to the at least one uplink transmission precoding parameter.
